(19) United States
(12) Patent Application Publication
(10) Pub. No.: US 2011/0035801 A1
(43) Pub. Date: Feb. 10, 2011

(54) METHOD, NETWORK DEVICE, AND NETWORK SYSTEM FOR DEFENDING DISTRIBUTED DENIAL OF SERVICE ATTACK

(76) Inventor: Hongxing Li, Chengdu (CN)

Correspondence Address: Huawei/BHGL, P.O. Box 10395, Chicago, IL, 60610, US

(21) Appl. No.: 12/908,679

(22) Filed: Oct. 20, 2010

Related U.S. Application Data
(63) Continuation of application No. PCT/CN2009/071274, filed on Apr. 15, 2009.

(30) Foreign Application Priority Data
May 23, 2008 (CN) 200810067376.9

(51) Int. Cl. G06F 11/00

(52) U.S. Cl. 726/22

(57) ABSTRACT

A method for defending a distributed denial of service (“DDoS”) attack includes analyzing at least one of a running status of a server or a network data stream flowing to the server at the server side to detect whether a DDoS attack occurs on the server and notifying a data stream cleaner that the data stream cleaner needs to clean the network data stream flowing to the server, if the DDoS attack occurs on the server.

### CROSS-REFERENCE TO RELATED APPLICATIONS

This application is a continuation of International Application PCT/CN2009/071274, filed on Apr. 15, 2009, which claims priority to Chinese Patent Application No. 200810067376.9, filed on May 23, 2008, both of which are hereby incorporated by reference in their entireties.

### FIELD OF THE DISCLOSURE

The present disclosure relates to the field of network security technology, and more particularly to a method, a network device, and a network system for defending a Distributed Denial of Service (“DDoS”) attack.

### BACKGROUND

The DDoS attack mainly utilizes the Internet Protocol and basic advantages of the Internet—transferring data packets from any sources to any destinations without deviation. The DDoS attack can be classified into two types: one is to overwhelm the network device and the server with a large quantity of data and high traffic, and the other is to purposefully make a great number of incomplete requests that cannot be done so as to rapidly exhaust the resources of the server.

The DDoS attack is a type of attack generated on the basis of the conventional Denial of Service (“DoS”) attack. The DDoS attack can use more puppet hosts to initiate an attack, and attack victims on a much larger scale than before. Technically, the DDoS attack includes threat to the security of computers in the Internet and placement of Trojan horse programs. A large number of Trojan horse programs may initiate an attack simultaneously at a specified time in a certain manner, following the instructions of a main server controlled by the attacker, so as to form a vast global Zombie-attacking network.

An important characteristic of the DDoS attack is to initiate an attack by lots of puppet hosts by sending abundance of data packets to the attacked target-side, so as to destroy, for example, the bandwidth or the transaction capability of the attacked target-side.

In order to release the pressure from the DDoS to the attacked target, a defending device may be placed before the attacked target. When the DDoS attack occurs, the defending device automatically filters the attacking streams, so as to block the DDoS attack outside of the filtering device.

The detection of an attack may be performed individually by the DDoS defending device according to characteristics of the DDoS attack, for example, an SYN Flood attack (a type of DDoS attack) is considered to occur, if a large number of SYN packets exceeding a certain threshold are detected, regardless of whether the attack effect on the attacked target is truly brought or not.

The DDoS defending device may filter the attacking packets by using a specific method according to the type of the attack, so as to filter out a large number of attacking packets and allow the normal accessing packets to pass through, thereby suppressing the attack to the attacked target to a certain extent.

Because the defending solution adopts a separate device, only the characteristics from the network traffic are detected to determine whether an attack occurs or not. For different attacked targets, the characteristics of the attack and the threshold for determining an attack cannot be easily defined. Therefore, there are error reports and some attacks are not reported.

### SUMMARY

The present disclosure is directed to a method for defending a DDoS attack includes the following steps:

At least one of a running status of a server or a network data stream flowing to the server is analyzed at the server side to detect whether a DDoS attack occurs on the server. A data stream cleaner is notified that it needs to clean the network data stream flowing to the server if the DDoS attack occurs on the server.

The present disclosure is further directed to a network device, which includes a DDoS attack defending module. The module includes a detecting unit and a notifying unit.

The detecting unit is configured to analyze a running status of the network device and/or a network data stream flowing to the network device at the network-device side to detect whether a DDoS attack occurs on the network device.

The notifying unit is configured to notify a data stream cleaner that the data stream cleaner needs to clean the network data stream flowing to the network device if the detecting unit detects that the DDoS attack occurs on the network device.

The present disclosure is further directed to a network system. The network system includes at least one network device and a data stream cleaner.

The network device is configured to receive and process a network data stream from the network side and comprises a DDoS attack defending module. The DDoS attack defending module is configured to analyze at least one of a running status of the network device or the network data stream flowing to the network device to detect whether a DDoS attack occurs on the network device. The DDoS attack defending module is further configured to notify the data stream cleaner that the data stream cleaner needs to clean the network data stream flowing to the network device if the DDoS attack occurs on the network device. The data stream cleaner is configured to negotiate with the network device and clean the network data stream according to a negotiation result.

### BRIEF DESCRIPTION OF THE DRAWINGS

The accompanying drawings for illustrating the embodiments of the present disclosure or the prior art are outlined below. The accompanying drawings are for the exemplary purpose only, and person having ordinary skill in the art can derive other drawings from such accompanying drawings without any creative effort.

FIG. 1 is a schematic diagram of the architecture of a network system according to Embodiment 1 of the present disclosure;

FIG. 2 is a flow chart of a method for defending a DDoS attack according to Embodiment 1 of the present disclosure;

FIG. 3 is a schematic diagram of the structure of a DDoS attack defending module according to Embodiment 1 of the present disclosure;

FIG. 4 is a schematic diagram of the architecture of a network system according to Embodiment 2 of the present disclosure;

FIG. 5 is a flow chart of a method for defending a DDoS attack according to Embodiment 2 of the present disclosure;

FIG. 6 is a schematic diagram of the structure of a DDoS attack defending module according to Embodiment 3 of the present disclosure; and

FIG. 7 is a schematic diagram of the structure of a DDoS attack defending module according to Embodiment 4 of the present disclosure.

### DETAILED DESCRIPTION OF THE PREFERRED EMBODIMENTS

The present disclosure is described below with reference to the accompanying drawings. The embodiments described below are for the exemplary purpose only, without covering all embodiments of the present disclosure. Those skilled in the art can derive other embodiments from the embodiments given herein without making any creative effort, and all such embodiments are covered in the protection scope of the present disclosure.

In the following embodiments, the network may be, for example, a mobile network, a fixed network, or a mobile-fixed-mobile convergence network; or a local area network, a metropolitan area network, or a wide area network; or an access network, a core network, or a transport network; or a point to point (“P2P”) network or a client/server (“C/S”) architecture network.

### Embodiment 1

According to this embodiment, a DDoS attack defending module is mounted on an attacked target server. The module may detect a running status of the server and/or a network data stream flowing to the server, and feed back a detection result to a data stream cleaner. The DDoS attack defending module at the server side may be hardware or software, for example but not limited to, network interface layer, kernel level, or application level software. The module may be independent software or a part of certain security software, and may also be hardware or software defending in various levels.

The running status of the server includes the running load or network traffic of a central processing unit (CPU) or a memory.

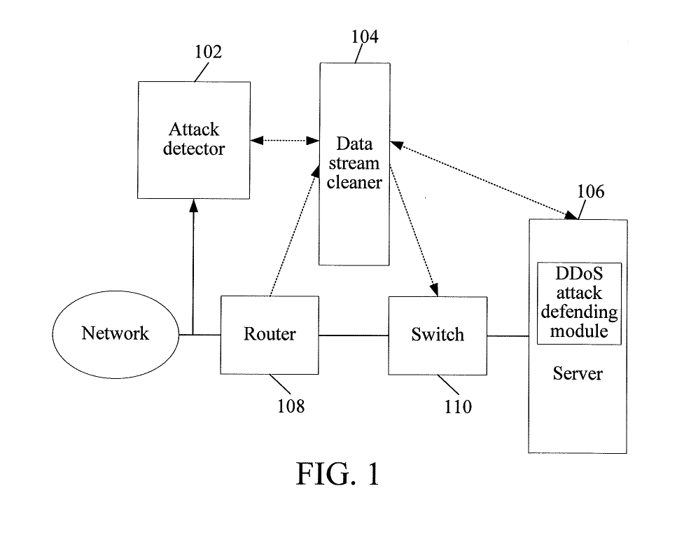

Referring to FIG. 1, the network system according to this embodiment includes an attack detector 102, a data stream cleaner 104, and at least one server 106.

The attack detector 102 is configured to examine a network data stream from the network side; and if it is detected that a DDoS attack occurs on the server, direct the attacking network data stream flowing to the attacked target to the data stream cleaner for cleaning by using a flow lead technology, and send the normal network data stream to the server. The attacked target of the DDoS attack may be recognized by using, for example, IP address or MAC address.

The data stream cleaner 104 is configured to negotiate with the attack detector and the server, and clean the network data stream according to a negotiation result.

The at least one server 106 is configured to receive and process the network data stream from the network side and includes a DDoS attack defending module. The DDoS attack defending module is configured to analyze a running status of the server and/or the network data stream flowing to the server, to determine whether a DDoS attack occurs, and send a detection result to the data stream cleaner; and notify the data stream cleaner that the data stream cleaner needs to clean the network data stream flowing to the network device, if the detecting unit detects that the DDoS attack occurs on the network device. The DDoS attack defending module may further clean the data stream that has been cleaned by the data stream cleaner.

The data stream cleaner can be deployed at any position before the server. As shown in FIG. 1, the data stream cleaner is deployed between a router 108 and a switch 110.

The cleaner and the DDoS attack defending module at the server side may have a linkage interface.

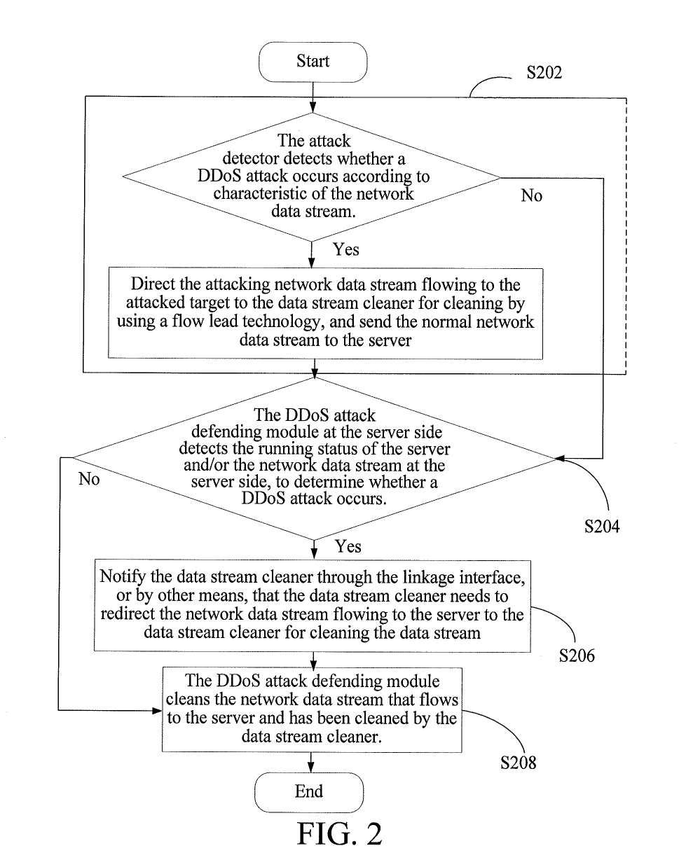

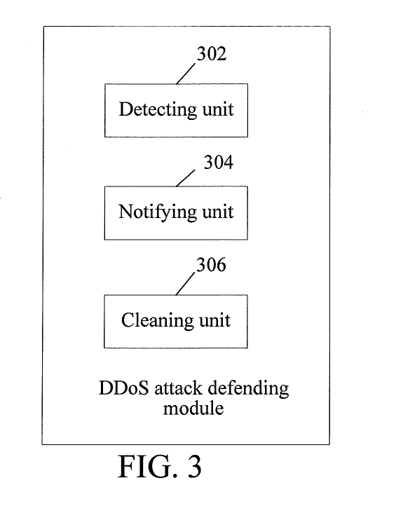

Referring to FIG. 2, the method for defending the DDoS attack according to this embodiment includes the following steps:

In step S202, the attack detector detects whether a DDoS attack occurs on the server according to characteristics of the network data stream, and if the DDoS attack is detected, directs the attacking network data stream flowing to the attacked target to the data stream cleaner for cleaning by using the flow lead technology, and sends the normal network data stream to the server. The attacked target may be recognized via, for example, IP address or MAC address.

In step S204, the DDoS attack defending module at the server side detects the running status of the server and/or the network data stream at the server side, to determine whether a DDoS attack occurs. Various engines and algorithms are adopted in the detection of the module, in order to find out the DDoS attack as soon as possible. The DDoS attack defending module works together with the detector module at the network side.

The detection at the server side may perform analysis base on streams, files, or protocols. Because the detection is carried out at the server side, higher sensitivity is achieved than that of the device at the network side, and thus more DDoS characteristics can be found than the network side.

In step S206, when determining that the DDoS attack occurs on the server, the DDoS attack defending module at the server side notifies the data stream cleaner through the linkage interface, or by other means, that the data stream cleaner needs to clean the network data stream flowing to the server to the data stream cleaner for cleaning. The DDoS attack defending module may extract characteristics of the attacking network packets, so as to notify the data stream cleaner that the data stream cleaner needs to clean the data stream.

The network data stream that has been cleaned may still contain a part of the DDoS attack, so the method of this embodiment may further include the following steps:

In step S208, the DDoS attack defending module cleans the network data stream that flows to the server and has been cleaned by the data stream cleaner.

The DDoS attack defending module according to this embodiment includes a detecting unit 302, a notifying unit 304, and a cleaning unit 306.

The detecting unit 302 is configured to analyze the running status of the server and/or the network data stream flowing to the server at the server side, to detect whether a DDoS attack occurs on the server.

The notifying unit 304 is configured to notify the data stream cleaner that the data stream cleaner needs to redirect the network data stream flowing to the server to the data stream cleaner for cleaning the data stream, if the detecting unit detects that the DDoS attack occurs on the server.

The cleaning unit 306 is configured to clean the network data stream flowing to the server.

### Embodiment 2

According to this embodiment, an attack detector does not need to be mounted at the network side, and instead, a DDoS attack defending module is mounted on an attacked target server.

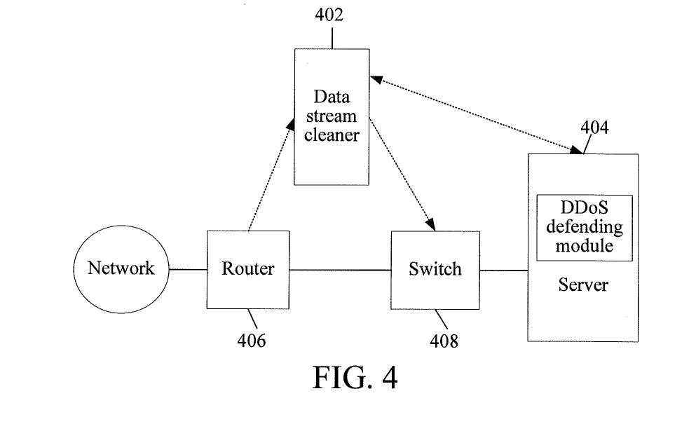

Referring to FIG. 4, the network system according to this embodiment includes a data stream cleaner 402 and at least one server 404.

The data stream cleaner 402 is configured to negotiate with the attack detector and the server and clean the network data stream according to a negotiation result.

The at least one server 404 is configured to receive and process the network data stream from the network side and includes a DDoS attack defending module. The DDoS attack defending module is configured to analyze the running status of the server and/or the network data stream to detect whether a DDoS attack occurs, and feed back a detection result to the data stream cleaner. The DDoS attack defending module may further clean the data stream that has been cleaned by the data stream cleaner.

The data stream cleaner can be deployed at any position before the server. As shown in FIG. 4, the data stream cleaner is deployed between a router 406 and a switch 408.

The cleaner and the DDoS attack defending module at the server side may have a linkage interface.

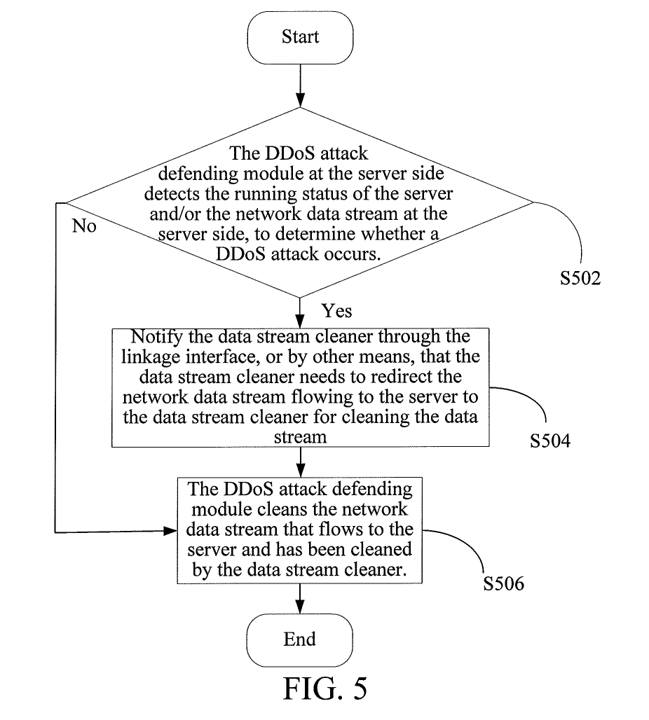

Referring to FIG. 5, the method of this embodiment includes the following steps:

In step S502, the DDoS attack defending module at the server side analyzes the running status of the server and/or the network data stream at the server side to detect whether a DDoS attack occurs. Various engines and algorithms are adopted in the detection of the module, in order to find out the DDoS attack as soon as possible. The DDoS attack defending module works together with the attack detector at the network side.

The detection at the server side may perform analysis base on streams, files, or protocols. Because the detection is carried out at the server side, higher sensitivity is achieved than that of the device at the network side, and thus more DDoS characteristics can be found than the network side.

In step S504, when detecting that the DDoS attack occurs on the server, the DDoS attack defending module at the server side notifies the data stream cleaner through the linkage interface, or by other means, that the data stream cleaner needs to redirect the network data stream flowing to the IP address of the server to the data stream cleaner for cleaning the data stream. The DDoS attack defending module may extract characteristics of the attacking network packets, so as to notify the data stream cleaner that the data stream cleaner needs to clean the data stream.

The network data stream that has been cleaned may still contain part of the DDoS attack, so the method of this embodiment may further include the following steps:

In step S506, the DDoS attack defending module cleans the network data stream that flows to the server and has been cleaned by the data stream cleaner.

### Embodiment 3

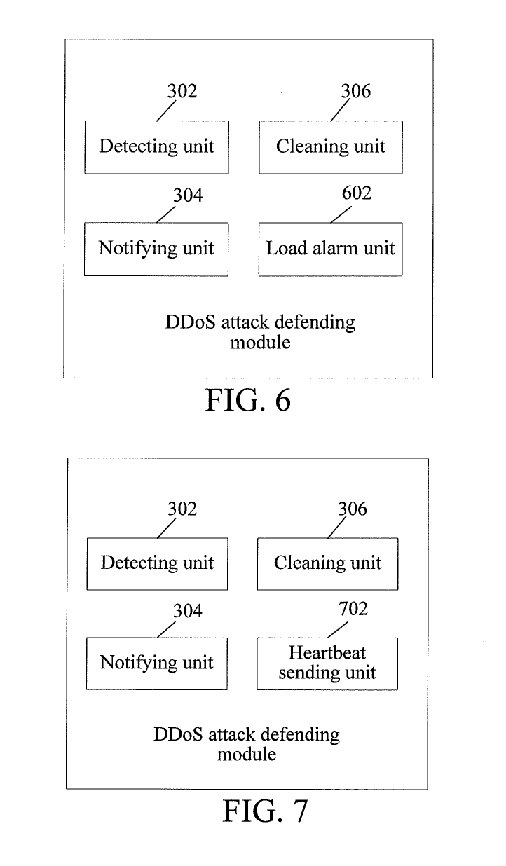

According to this embodiment, a load alarm mechanism is added to the server. As shown in FIG. 6, the DDoS attack defending module further includes a load alarm unit 602.

The load alarm unit 602 is configured to monitor the traffic of the network data stream flowing to the server, and raise an alarm to the data stream cleaner when the traffic of the network data stream reaches a preset value, for example, a self-defined hazard level.

The detection of the traffic flowing to the server is accomplished by the detection of the traffic on the network card. The detection may be linked to the cleaning and filtering strength of the data stream cleaner, according to grades classified by the bearing capability. When the traffic passing through the network card of the server reaches a hazard level, an alarm is raised to the data stream cleaner.

According to this embodiment, alarm and defense of the DDoS attack can be carried out according to the traffic at the server side, so that the security is enhanced.

### Embodiment 4

According to this embodiment, a heartbeat linkage is established between the server and the detector, and the detector may be a data stream cleaner.

When the CPU resources of the server have been exhausted, the host cannot send any message, and it may be determined whether the server breaks down by detecting the heartbeat. The data stream cleaner starts rescuing the server after detecting that the host has broken down. The rescue measures are described in the following:

(1) Limit the traffic flowing to the server in the data stream cleaner, in which the traffic-limit may be at a rescue level; detect whether the heartbeat is recovered; and restart the server if the heartbeat is not recovered.

(2) After the heartbeat is recovered, the detector analyzes the “breakdown reason” and improves the filtering rules, in which the detector may be a cleaner.

As shown in FIG. 7, the DDoS attack defending module further includes a heartbeat sending unit 702.

The heartbeat sending unit 702 is configured to send heartbeats to the data stream cleaner.

According to this embodiment, the data stream cleaner is notified by the heartbeats that it needs to limit the traffic when the server side breaks down under the DDoS attack, thereby effectively defending the DDoS attack and enhancing the security.

In the above embodiments, the attacked target server in different network environments may be other types of device, such as a computer, a mobile phone, a network node (for example, a router, a switch, or a base station), or a household appliance.

Persons skilled in the art may further realize that, in combination with the embodiments herein, units and algorithm steps of each example described can be implemented with electronic hardware, computer software, or the combination thereof. In order to clearly describe the interchangeability between the hardware and the software, compositions and steps of each example have been generally described according to functions in the foregoing descriptions. Whether the functions are executed in a mode of hardware or software depends on particular applications and design constraint conditions of the technical solutions. Persons skilled in the art can use different methods to implement the described functions for each particular application, but it should not be considered that the implementation goes beyond the scope of the present disclosure.

In combination with the embodiments herein, steps of the method or algorithm described may be directly implemented using hardware, a software module executed by a processor, or the combination thereof. The software module may be placed in a random access memory (RAM), a memory, a read-only memory (ROM), an electrically programmable ROM (EPROM), an electrically erasable programmable ROM (EEPROM), a register, a hard disk, a removable magnetic disk, a CD-ROM, or any storage medium of other forms well-known in the technical field.

The above descriptions are merely preferred embodiments of the present disclosure, but are not intended to limit the present disclosure. Any modification, equivalent replacement, or improvement made without departing from the principle of the present disclosure should fall within the scope of the present disclosure.

What is claimed is:

1. A method for defending a distributed denial of service (DDoS) attack, comprising
analyzing at least one of a running status of a server or a network data stream flowing to the server at the server side, to detect whether a DDoS attack occurs on the server; and
notifying a data stream cleaner that the data stream cleaner needs to clean the network data stream flowing to the server if a DDoS attack occurs on the server.

2. The method according to claim 1, further comprising:
cleaning the network data stream by the data stream cleaner at the server side.

3. The method according to claim 1, further comprising:
before the analyzing at least one of the running status of the server or the network data stream flowing to the server at the server side, analyzing the network data stream at the network side, by an attack detector, to detect whether a DDoS attack occurs on the server, and
if a DDoS attack occurs on the server, directing the network data stream flowing to the server to the data stream cleaner for cleaning.

4. A network device comprising a distributed denial of service (DDoS) attack defending module, wherein the DDoS attack defending module comprises:
a detecting unit, configured to analyze at least one of a running status of the network device or a network data stream flowing to the network device at the network-device side to detect whether a DDoS attack occurs on the network device; and
a notifying unit, configured to notify a data stream cleaner that the data stream cleaner needs to clean the network data stream flowing to the network device if the detecting unit detects that the DDoS attack occurs on the network device.

5. The network device according to claim 4, wherein the DDoS attack defending module further comprises:
a cleaning unit configured to clean the network data stream flowing to the network device.

6. The network device according to claim 4, wherein the DDoS attack defending module further comprises:
a load alarm unit configured to monitor traffic of the network data stream flowing to the network device, and when the traffic of the data stream reaches a preset value, send an alarm to the data stream cleaner.

7. The network device according to claim 4, wherein the DDoS attack defending module further comprises:
a heartbeat sending unit configured to send heartbeats to the data stream cleaner.

8. A network system comprising at least one network device and a data stream cleaner, wherein:
the network device is configured to:
receive and process a network data stream from a network side where the network device comprises a distributed denial of service (DDoS) attack defending module configured to analyze at least one of a running status of the network device or the network data stream flowing to the network device to detect whether a DDoS attack occurs on the network device, and
notify the data stream cleaner that the data stream cleaner needs to clean the network data stream flowing to the network device if the DDoS attack occurs on the network device; and
the data stream cleaner is configured to negotiate with the network device and clean the network data stream according to a negotiation result.

9. The network system according to claim 8, further comprising:
an attack detector configured to:
analyze the network data stream from the network side to detect whether the DDoS attack occurs on the network device, and
if the DDoS attack occurs on the network device, direct the network data stream flowing to the network device to the data stream cleaner for cleaning.

10. The network system according to claim 8, wherein the network device comprises: a computer, a server, a mobile phone, a router, a switch, or a base station.
